(19) United States
(12) Patent Application Publication
(10) Pub. No.: US 2025/0033026 A1
(43) Pub. Date: Jan. 30, 2025

(54) POLYAMINE SORBENTS ON AMORPHOUS HIGH PORE VOLUME SUPPORTS

(71) Applicant: EXXONMOBIL TECHNOLOGY AND ENGINEERING COMPANY, Spring, TX (US)

(72) Inventors: Scott WEIGEL, Allentown, PA (US); Wesley SATTLER, Parsippany, NJ (US); Allen BURTON, Stewartsville, NJ (US); Keith HAJKOWSKI, Somerset, NJ (US); Ryan DUGAN, Milford, NJ (US); Aaron PETERS, New Hope, PA (US)

(21) Appl. No.: 18/784,261

(22) Filed: Jul. 25, 2024

Related U.S. Application Data
(60) Provisional application No. 63/516,023, filed on Jul. 27, 2023.
(60) Provisional application No. 63/516,030, filed on Jul. 27, 2023.
(60) Provisional application No. 63/516,020, filed on Jul. 27, 2023.
(60) Provisional application No. 63/568,661, filed on Mar. 22, 2024.

(51) Int. Cl. B01J 20/26; B01J 20/32

(52) U.S. Cl. CPC B01J 20/262; B01J 20/3204

(57) ABSTRACT

Amorphous silica-alumina support materials are provided that can serve as supports for polyamines. The silica-alumina support materials have a combination of properties that unexpectedly allow supported polyamines to retain an increased or maximized amount of CO₂ sorption capacity after incorporation of substantial amounts of the polyamine on the support material. This combination of properties can include having a high pore volume, a high ratio of mesopore volume to micropore volume, and a sufficiently high acidity. The ability to allow supported amine sorbents to retain additional CO₂ sorption capacity is unexpected. Additionally, the relationship between having sufficiently high acidity and providing improved sorption capacity for a supported amine material is unexpected.

### CLAIMS-REFERENCE TO RELATED APPLICATIONS AND PRIORITY CLAIM

This Non-Provisional patent application claims priority to U.S. Provisional Patent Application No. 63/516,023, filed Jul. 27, 2023, and titled “Polyamine Sorbents on Amorphous High Pore Volume Supports”. This application also claims priority to U.S. Provisional Patent Application No. 63/516,030 filed on Jul. 27, 2023, U.S. Provisional Patent Application No. 63/516,020 filed on Jul. 27, 2023, and U.S. Provisional Patent Application No. 63/568,661 filed on Mar. 22, 2024. The entire contents of each of the above documents is hereby incorporated by reference into the present application.

### FIELD OF THE INVENTION

Supported polyamine compositions are provided based on high pore volume supports, along with methods of forming and using the compositions.

### BACKGROUND OF THE INVENTION

One strategy for performing CO₂ capture is to perform a process cycle where CO₂ is first sorbed using a solid sorbent, and then desorbed in a subsequent part of the cycle. This can allow CO₂ to be selectively removed from a gas flow. A variety of amines have been previously investigated for potential use as sorbent materials for CO₂ capture.

One difficulty with using amines is balancing the various considerations that are desirable for a sorbent material. Preferably, a sorbent material can have a relatively low cost of manufacture, a high sorption capacity per weight/volume of the material, and a long operating lifetime before breakdown and/or degradation. It would be desirable to develop materials with improved combinations of these features.

Another difficulty with is providing the amine in an environment that allows for efficient exposure of the amine to a CO₂-containing gas (such as air) in an efficient manner while maintaining a substantial majority of the sorption capacity. Conventionally, for CO₂ sorbent materials that require a support to provide a solid structure, a common technique is to support the sorbent on a high surface area support. The support can optionally be deposited on a structural material, such as a monolith, to provide a geometry that assists with exposing a gas flow to the sorbent. However, for polyamines such as polyethyleneimine, supporting the polyamine on a high surface area support typically results in a substantial loss of sorbent capacity on a CO₂ sorption per gram basis.

A journal article titled “Epoxy Cross-Linked Polyamine CO₂ Sorbents Enhanced via Hydrophobic Functionalization” (Chem Mater. Vol. 31, No. 13, p 4673, 2019) describes modification of polyethyleneimine with hydrophobic additives, such as 2-ethylhexyl glycidyl ether. The modified polyethyleneimine is then cross-linked using bisphenol-A diglycidyl ether to form a support-free sorbent material. These materials are shown to be able to tune adsorption efficiency, but do not take into account operating lifetime.

A journal article by Choi et al. titled “Epoxide-functionalization of polyethyleneimine for synthesis of stable carbon dioxide adsorbent in temperature swing adsorption” (Nat. Commun. 7:12640 doi: 10.1038/ncomms12640 (2016)) describes assignment of primary, secondary, and tertiary amines using ¹³C NMR spectroscopy.

Some review articles have provided overviews of recent efforts to form sorbent systems based on polyethyleneimine supported on mesoporous silica. One review is “Stability of Amine-Functionalized CO₂ Adsorbents: A Multi-Faceted Puzzle”, (Lashaki et al., Chem. Soc. Rev. 2019 48 3320). Another review is “Direct Capture of CO₂ from Ambient Air”, (Sanz-Perez et al., Chem. Rev. 2016 116 11840).

Other journal articles have focused on specific systems, such as supporting polyethylene imine on zeolite 13X or ZSM-5. An example of such an article is “Polyethyleneimine-incorporated Zeolite 13X with Mesoporosity for Post-Combustion CO₂ Capture”, (Chen et al Appl. Surf. Sci. 2015 332 167). Another example is “Effects of Pore Structure and PEI Impregnation on Carbon Dioxide Adsorption by ZSM-5 Zeolites”, (Lee et al., J. Industrial Eng. Chem. 2015 23 251). Still another example is “Polyethyleneimine-Modified Zeolite 13X for CO₂ Capture: Adsorption and Kinetic Studies”, (Karka et al., ACS Omega 2019 4 16441).

### SUMMARY

In an aspect, a supported amine sorbent is provided. The supported amine sorbent includes an amorphous support material containing silica and alumina. The support material can have a pore volume of 1.00 g/cm³ or more, a ratio of mesopore volume to micropore volume of 1.0 or more, a total surface area of 100 m²/g or more, a ratio of Si to Al₂ of 10-49, and/or an acidity as measured by temperature programmed ammonia desorption of 0.10 meq/g or more. Additionally, the supported amine sorbent can include 30 wt % to 80 wt % of a polyamine supported on the support material, relative to a weight of the support material.

### BRIEF DESCRIPTION OF THE DRAWINGS

FIG. 1 shows characterization data for various support materials.

FIG. 2 shows CO₂ capacities for amines supported on various support materials.

FIG. 3 shows CO₂ capacity for PEI supported on amorphous silica-alumina versus the ratio of mesopore to micropore volume for the amorphous silica-alumina.

FIG. 4 shows CO₂ capacity for PEI supported on EMM-57 support materials with various mesopore volumes.

FIG. 5 shows thermogravimetric analysis measurements of weight gain for supported polymer materials in the presence of CO₂.

FIG. 6 shows thermogravimetric analysis measurements of weight loss for supported polymer materials when exposed to various conditions.

FIG. 7 shows changes in CO₂ capacity over time during exposure of supported polymer materials to cyclic conditions for oxidation at 140° C. and CO₂ sorption.

FIG. 8 shows changes in CO₂ capacity over time during exposure of supported polymer materials to cyclic conditions for oxidation at 120° C. and CO₂ sorption.

FIG. 9 shows CO₂ breakthrough data for various unmodified and modified PEI samples.

FIG. 10 shows CO₂ sorption kinetics determined based on the breakthrough data shown in FIG. 9.

FIG. 11 shows assignment of primary, secondary, and tertiary amines in unmodified and modified PEI samples using ¹³C NMR.

### DETAILED DESCRIPTION

### Overview

In various aspects, amorphous silica-alumina support materials are provided that can serve as supports for polyamines. The silica-alumina support materials have a combination of properties that unexpectedly allow supported polyamines to retain an increased or maximized amount of CO₂ sorption capacity after incorporation of substantial amounts of the polyamine on the support material. This combination of properties can include having a high pore volume, a high ratio of mesopore volume to micropore volume, and a sufficiently high acidity. The ability to allow supported amine sorbents to retain additional CO₂ sorption capacity is unexpected. Conventionally, even when high pore volume support materials are used to support an amine sorbent, only a limited amount of the amine sorbent can be supported on the support material before substantial losses of sorbent capacity occur relative to the amount of amine sorbent. Additionally, the relationship between having sufficiently high acidity and providing improved sorption capacity for a supported amine material is unexpected.

It has also been discovered that the support materials having high pore volume, high ratio of mesopore volume to micropore volume, and sufficiently high acidity can retain the advantage of facilitating sorption by supported amines when the supported amines are deposited on a support structure, such as a monolith.

A variety of amine-based sorbent materials are available that have high sorption capacity for CO₂. However, to use such sorbent materials for CO₂ sorption on a commercial scale, the sorbent materials either have to be self-supporting, or the sorbent materials have to be supported on another material. While it is feasible to use some amine-based materials as self-supported structures, there is typically a substantial reduction in CO₂ sorption capacity relative to laboratory scale sorption tests. This is due in part to difficulties in allowing a CO₂-containing gas to reach the full volume of the self-supporting structure. Thus, it would be desirable to have support materials that can support amine-based sorbents while retaining a higher percentage of the potential sorption capacity of the amine-based sorbent. Additionally, it would be desirable to be able to achieve a high loading of amine-based sorbent relative to the weight of the support material, so that the resulting supported amine-based sorbent has a high CO₂ sorption capacity per unit volume.

### Definitions

In this discussion, a zeotype is defined to refer to a crystalline material having a porous framework structure built from tetrahedra atoms connected by bridging oxygen atoms. Examples of known zeotype frameworks are given in the “Atlas of Zeolite Frameworks” published on behalf of the Structure Commission of the International Zeolite Association”, 6^{th} revised edition, Ch. Baerlocher, L. B. McCusker, D. H. Olson, eds., Elsevier, New York (2007) and the corresponding web site, http://www.iza-structure.org/databases/. Under this definition, a zeolite refers specifically to an aluminosilicate having a zeotype framework structure. Under this definition, a zeotype can refer to aluminosilicates (i.e., zeolites) having a zeotype framework structure as well as zeotype framework structures containing oxides of atoms different from silicon and aluminum. Such oxides can include oxides of any other atoms generally known to be suitable for inclusion in a zeotype framework, such as oxides gallium, boron, germanium, phosphorus, zinc, and/or other transition metals that can substitute for silicon and/or aluminum in a zeotype framework. It is noted that under this definition, a zeotype can include materials such as silicoaluminophosphate (SAPO) materials or aluminophosphate (AlPO) materials.

In this discussion, crystalline materials are defined as materials that have an ordered microscopic structure that is capable of diffracting X-rays. Crystalline materials can include, but are not limited to, zeotypes (i.e., materials having a zeotype framework structure) and clays that have sufficient long-range order to be capable of diffracting X-rays. Examples of crystalline zeotypes can include zeolites (materials composed of silicon, aluminum, and oxygen) and SAPOs (materials composed of silicon, aluminum, phosphorus, and oxygen). Examples of atoms different from silicon, aluminum, and oxygen that can be present in a material having a zeotype framework structure include, but are not limited to, Ge, Ga, B, P, and Zn.

In this discussion, a “hierarchical structured zeotype” material is defined as a zeotype material (having a zeotype framework structure) that has at least two levels of pore diameters. A first level of pore diameters corresponds to pores with diameters of less than or equal to 2.0 nm, while the second level of pore diameters corresponds to pores with diameters greater than 2.0 nm. In other words, hierarchical structured zeotypes not only have inherent microporosity, but also have mesoporosity or even macroporosity. Such hierarchical structured materials typically have crystal sizes of less than 1.0 microns. It is noted that although materials such as MCM-41 and MCM-48 have mesoporous channels that are defined as part of the corresponding zeotype framework structure, such materials lack microporosity, and therefore are not inherently within the definition of hierarchical structured zeotype materials.

In this discussion, references to a periodic table are defined as references to the current version of the IUPAC Periodic Table.

In this discussion, the term “polyamine” is defined to include polyamines that include other functional groups, such as polyhydroxylamines or functionalized polyamines. Thus, a modified polyamine that is modified by cross-linking with a cross-linker as described herein also falls within the definition of a polyamine.

### Support Materials

One property of an amorphous silica-alumina support material is a high pore volume. In various aspects, a support material can have a pore volume of 1.20 g/cm³ or more, or 1.40 g/cm³ or more, such as up to 2.5 g/cm³ or possibly still more. In this discussion, pore volume is BET pore volume determined according to ASTM D6761. High pore volume can potentially be beneficial for providing additional surface area for the polyamine sorbent. However, conventional attempts to support polyamines on high pore volume supports have taken into account other factors that impact the sorption capacity of the supported polyamine.

In addition to having a sufficient pore volume, a support material can have one or more additional properties. In some aspects, a support material can have an average pore diameter between 5.0 nm and 200 nm, or 5.0 nm to 150 nm, or 5.0 nm to 100 nm, or 5.0 nm to 50 nm, or 10 nm to 200 nm, or 10 nm to 150 nm, or 10 nm to 100 nm, or 10 nm to 50 nm. Average pore diameter is calculated as 4V/A, where V is the BET pore volume and A is the BET total surface area, as determined according to ASTM D6761. Total area is determined according to ASTM D4365. Without being bound by any particular theory, it is believed that larger pore volumes facilitate access of the additional surface area by polyamines.

Another potential consideration is the ratio of mesopore volume to micropore volume. In some aspects, a support material can have a mesopore volume that is equal to or greater than the micropore volume. In such aspects, the ratio of mesopore volume to micropore volume can be 1.0 or more, or 1.2 or more, or 1.5 or more, such as up to 2.5 or possibly still higher. In this discussion, mesopores are defined as pores having a pore diameter of roughly 2 nm to 50 nm. It is noted that ASTM D4365 also provides mesopore volume, which therefore allows for calculation of micropore volume by subtracting the mesopore volume from the total pore volume. Without being bound by any particular theory, it is believed that having a high mesopore volume relative to the micropore volume facilitates allowing the polyamine to enter pores while reducing or minimizing clogging of pores that would restrict sorption capacity.

Still other factors can be related to the available surface area. Materials with increased surface area can potentially distribute a given amount of an amine sorbent over a larger area, allowing for a thinner layer of amine supported on the material. However, it has been discovered that total surface area alone does not indicate whether a material can provide improved performance for retaining CO₂ sorption capacity when used as a support for a supported amine. Instead, the ratio of external surface area to total surface area is also relevant. In some aspects, a support material can have a total surface area of 350 m²/g or more, or 400 m²/g or more, or 450 m²/g or more, such as up to 800 m²/g or possibly still higher. Additionally or alternately, a support material can have a ratio of external surface area to total surface area of 0.15 or more, or 0.20 or more, or 0.25 or more, such as up to 0.50 or possibly still higher.

Yet another factor can be the relative amounts of silica and alumina in the silica-alumina. In some aspects, the amorphous silica-alumina can include 20 wt % or more of silica relative to a weight of the amorphous silica-alumina, or 30 wt % or more, such as up to 90 wt %. In some aspects, the amorphous silica-alumina can include 10 wt % or more of alumina, or 20 wt % or more, such as up to 80 wt %. In addition to silica and alumina, the amorphous silica-alumina can include 15 wt % or less of oxides different from silica and alumina, or 10 wt % or less, such as down to being substantially composed of silica and alumina. In other words, the amorphous silica-alumina can have a combined weight of silica and alumina of 85 wt % or more relative to a weight of the amorphous silica-alumina, or 90 wt % or more, such as up to being substantially composed of silica and alumina. In other aspects, the amorphous silica-alumina can consist essentially of silica and alumina, so that less than 1.0 wt % of the amorphous silica-alumina corresponds to atoms different from silicon, aluminum, and oxygen.

Yet another factor can be the ratio of silicon to aluminum in the support material. Examples of ranges for Si to Al₂ include 10-1000, or 10-300, or 10-150, or 10-100, or 10-49, or 10-30, or 30-1000, or 30-300, or 30-150, or 30-100, or 50-1000, or 50-300, or 50-150. For crystalline materials such as zeolitic materials, the ratio of Si to Al₂ (silica to alumina) in the crystalline material can be 1000 or less, or 300 or less, or 150 or less, or 100 or less, such as down to 10 or possibly still lower. In some aspects, a crystalline support material with a hierarchical structure and/or a crystal sizes too small to resolve with X-ray diffraction can have a Si to Al₂ ratio of 50 or more. For amorphous silica-alumina materials, in some aspects the amorphous silica-alumina can include 20 wt % or more of silica relative to a weight of the amorphous silica-alumina, or 30 wt % or more, such as up to 90 wt %. In some aspects, the amorphous silica-alumina can include 10 wt % or more of alumina, or 20 wt % or more, such as up to 80 wt %. In addition to silica and alumina, the amorphous silica-alumina can include 15 wt % or less of oxides different from silica and alumina, or 10 wt % or less, such as down to being substantially composed of silica and alumina. In other words, the amorphous silica-alumina can have a combined weight of silica and alumina of 85 wt % or more relative to a weight of the amorphous silica-alumina, or 90 wt % or more, such as up to being substantially composed of silica and alumina. In some aspects, a support material (crystalline or amorphous) can consist essentially of oxides of silicon and aluminum, so that less than 1.0 wt % of the material corresponds to atoms different from silicon, aluminum, and oxygen, or less than 0.1 wt %, such as down to no heteroatom content.

Still another factor can be the acidity of a material. In some aspects, a support material can have an acidity, as measured by temperature programmed ammonia desorption (TPAD), of 0.10 meq/g or more, or 0.15 meq/g or more, such as up to 0.50 meq/g or more.

Amorphous support materials that can satisfy a plurality of the above properties will not have an X-ray diffraction (XRD) pattern that shows long range order and/or crystallinity, i.e. there will be no definitive peaks that are representative of a crystalline material due to the ordering of the atoms based upon their symmetry and crystallographic space groups, however there may be broad peaks indicative of some short range ordering of the material.

Formation of High Pore Volume Support with Supported Amine-Based Sorbent

The support material can be used to support an amine-based sorbent, such as a sorbent suitable for sorption of CO₂. The sorbent material can include primary amines, secondary amines, tertiary amines, or a combination thereof. The molecular weight of the sorbent material can range from 200 g/mol (equivalent to Daltons) to 1,000,000 g/mol, or 200 g/mol to 100,000 g/mol. Polyethyleneimine (PEI) is an example of a suitable polyamine. Other types of polyamine polymers (including polyimines) can also be used, such as polyhydroxylamine. Still other examples of polyamines include, but are not limited to, polyvinylamine, polypropyleneimine, polyallylamine, poly(2-dimethylaminoethyl acrylate), poly(2-dimethylaminoethyl methacrylate) and other vinyl polymers. Such polymeric materials can be branched or unbranched. In some aspects, the polyamine can correspond to a functionalized polyamine, such as a polyamine that has been cross-linked. For example, a polyamine can be reacted with a multi-dentate linker to form a cross-linked polyamine material.

In some aspects, the polyamine can correspond to a low molecular weight polyamine. For example, a low molecular weight polyamine can have a weight average molecular weight of 500 Da (Daltons) to 15,000 Da, or 500 Da to 10,000 Da, or 500 Da to 5,000 Da, or 500 Da to 2,000 Da, or 500 Da to 1,500 Da. Additionally or alternately, the low molecular weight polyamine can have a number average molecular weight of 500 Da (Daltons) to 5,000 Da, or 500 Da to 2,500 Da, or 500 Da to 1,300 Da, or 500 Da to 1,000 Da. It is noted that for many types of polymers, there is a difference between the number average molecular weight and the weight average molecular weight (i.e., polydispersity). Polydispersity is defined as the ratio of the weight average molecular weight divided by the number average molecular weight. In some aspects, the polydispersity for the polyamine can be 1.5 or less, or 1.4 or less, or 1.3 or less, such as down to 1.0 (i.e., having substantially no polydispersity).

In various aspects, a supported sorbent can be formed by supporting an amine-based sorbent on a high pore volume support material as described herein. In various aspects, the loading of amine-based sorbent on the support can correspond to 30 wt % relative to the combined weight of sorbent and support material, or 40 wt % or more, or 50 wt % or more, such as up to 75% or possibly still higher. In some aspects, the loading of amine-based sorbent on the support can be 30 wt % to 75 wt % relative to the combined weight of the sorbent and support material, or 30 wt % to 60 wt %, or 40 wt % to 75 wt %, or 40 wt % to 60 wt %.

To deposit an amine-based sorbent on a support, the amine-based sorbent can be dissolved and/or dispersed in a solvent. In various aspects, the solvent can include water, methanol, ethanol, propanol, iso-propanol, propylene glycol (glycols), propylene glycol propyl ether (glycol ethers), hexane, toluene, and combinations thereof. One factor in selecting a solvent is the solubility of the polymer or other amine in the solvent, in order to obtain the highest dispersion possible on the support. Depending on the aspect, the solvent may be paraffinic, aromatic, and/or may contain functional groups such as hydroxyls or ether linkages. In some aspects, the solvent can have a boiling point of 200° C. or less, such as down to 50° C. To facilitate removing the solvent when loading an amine on a support, it can be beneficial for the solvent to be easily removed by simple evaporation, thermal evaporation, or by vacuum. Additionally or alternately, it can be beneficial to have a solvent that can solubilize the amine (such as a polymeric amine) at concentrations between 0.1 wt % to 75 wt % % of amine in the solvent, or 1.0 wt % to 50 wt %.

To illustrate depositing an amine on a support, an example procedure is provided using methanol as a solvent for depositing polyethylene imine (PEI). It is understood that other combinations of solvent and/or amine can similarly be used.

First, PEI was dissolved in methanol. The mixture of PEI and methanol was mixed until the PEI was dissolved/dispersed in the methanol to form a clear or substantially clear solution. Concentrations of PEI were dissolved ranging from 1.0 wt % to 50 wt % PEI relative to the total weight of the solution.

Based on the weight of PEI (or another amine) in solution, the amount of PEI for loading on the support (wt PEI on support) can be calculated. The calculations are based on the weight of the support material (wt support), the target weight percentage loading of PEI on the support material (wt % loading PEI), and the weight percentage of PEI relative to the weight of the solution (wt % PEI in solution). Based on these values, the amount of PEI that will be deposited on a support can be calculated as

wt PEI on support=(wt support)*(wt % loading of PEI/100))/((1−(wt % loading of PEI/100)) (1)

The amount of solution used for the impregnation is calculated as

wt of solution=wt PEI on support/(wt % PEI in solution/100) (2)

For example, impregnating 10 g of zeolite to a 60 wt % loading of PEI requires 10 g of material to be slurried in 100 g of a 15% solution of PEI in MeOH.

To impregnate a support, the desired amount of support material to be impregnated can be weighed out. The target amount of PEI solution is then added to the support material powder to form a slurry. The slurry is then mixed for 6 to 18 hours in a sealed vessel. After the mixing (i.e., after the completion of the impregnation), the solvent can be removed in any convenient manner, such as through room temperature evaporation, in a forced air oven set at a temperature near the boiling point of the solvent, or in a vacuum oven. After solvent removal, the resulting material should be dry to slightly wet. The resulting material can then be tested for CO₂ capacity as measured by thermogravimetric analysis (TGA).

### Structural Supports and Bonding Layers

In some aspects, an amine sorbent supported on a support material could be used for sorption of CO₂ by depositing the amine sorbent on particles of the support material. Such particles could then be used, for example, as a packed bed. However, passing a gas flow through a packed bed can tend to result in a noticeable pressure drop. One option for reducing or minimizing pressure drop while still providing the supported amine sorbent throughout a volume is to deposit the supported amine sorbent on a structural support that includes flow channels. A monolith is an example of a structural support. The flow channels of the monolith can provide a large surface area for contacting a gas flow with the supported amine sorbent by coating one or more surfaces within the flow channels with the supported amine sorbent. Because each individual cell provides surface area for deposition of the supported amine sorbent, including a large number of cells or channels per unit area can substantially increase the available surface area for the sorbent. Similarly, a large number of channels can facilitate higher volume flow rates while reducing or minimizing pressure drop. Such monoliths can generally be referred to as honeycomb monoliths. It is noted that the terms “cell” and “channel” can be used interchangeably to refer to the passages through a monolith.

The monolith can have any convenient shape suitable for use as a surface for receiving a supported amine sorbent and/or other bonding layers. The monoliths can be fabricated from any convenient material that can withstand the sorption environment while being substantially non-reactive in the presence of the gas flows. One option is to use a ceramic type monolith, such as a monolith composed of alumina or an alumina alloy. Additionally or alternately, a monolith can correspond to an extruded structure. A small reactor may include a single monolith, while a larger reactor can include a number of monoliths, while a still larger reactor may be substantially filled with an arrangement of many honeycomb monoliths. Each monolith may be formed by extruding monolith blocks with shaped (e.g., square, trigonal, or hexagonal) cross-section and two- or three-dimensionally stacking such blocks above, behind, and beside each other.

In some aspects, honeycomb monoliths can be characterized as having open frontal area (or geometric void volume) between 30% to 70%, or 30% to 60%, or 40% to 70%, or 40% to 60%, or 45% to 55%. Additionally or alternately, a monolith can have a conduit density between 50 to 900 cells per square inch (CPSI), or 50 to 600, or 300 to 900, or 300 to 600, or 350 to 550. This roughly corresponds to 7 to 140 cells per square centimeter, or 45 to 140, or 7 to 95, or 45 to 95, or 55 to 85. In some aspects, this type of cell density roughly corresponds to cells or channels that have a diameter/characteristic cell side length of only a few millimeters, such as on the order of roughly one millimeter.

### Modified Polyamine Sorbent Materials

In some aspects, any convenient type of amine-based sorbent can be supported on a support material as described herein. In other aspects, the sorbent material supported on the support can correspond to a modified polyamine sorbent material.

In various aspects, sorbent materials are provided with selectivity for sorption of CO₂. The sorbent materials are formed by using a multi-dentate reagent to react with a relatively low molecular weight polyamine, such as a relatively low molecular weight polyethyleneimine (PEI). This forms a new modified polymer material that can be supported on a support material to provide a supported sorbent material. The multi-dentate reagent can correspond to, for example, a di-epoxy, a tri-epoxy, or another multi-dentate reagent that would be expected to have cross-linking activity with a polyamine. The amount of the multi-dentate reagent can be low enough so that only a reduced or minimized number of the nitrogen atoms in the polyamine are reacted during the cross-linking. Other examples of multi-dentate ligands can include, but are not limited to, multi-functional aldehydes (either with or without reductive amination), multi-functional halides, multi-functional isocyanates, and ligands including combinations of epoxies, aldehydes, halides, and/or isocyanates. The resulting modified polymer material can maintain the desirable sorption capacity of a lower molecular weight polyamine while having reduced volatility and/or increased resistance to oxidation. The reduced volatility and/or increased resistance to oxidation can allow the resulting modified polymer material to maintain capacity for sorption for longer periods of time. Additionally, by using a reduced or minimized amount of the multi-dentate reagent, the reduced volatility and/or increased resistance to oxidation can be achieved while still substantially maintaining a high CO₂ sorption capacity for the resulting supported modified polyamine material.

Selecting an amine-based material for sorption and desorption of CO₂ typically involves balancing a variety of factors. One type of material that would be desirable for CO₂ sorption/desorption is polyamines. A number of types of polyamine materials can be readily synthesized, providing a relatively low cost material with a high density of potential CO₂ sorption sites. However, a number of challenges remain with implementing such polyamines.

Some challenges are related to sorption capacity. For example, polyamines that correspond to polymeric amines provide a repeating structure that includes a potential CO₂ sorption site in each repeat unit, as the molecular weight of a polyamine increases, the sorption capacity of the polyamine tends to decrease. Thus, based on sorption capacity considerations, a lower molecular weight polyamine would be preferable.

Other challenges are related to stability of a polyamine sorbent system over an extended period. In order to increase availability of sorption sites, it is desirable to support a polyamine sorbent on a support with relatively high surface area. Examples of support materials can include high surface area refractory oxides (such as alumina) and/or zeotype supports. Unfortunately, as the molecular weight of a polyamine decreases, the volatility of the polyamine increases. Volatility is undesirable because it can lead to loss of polyamine from a support during normal operation, especially at the higher temperature parts of the process, which a sorbent is exposed to during the desorption step in a sorption/desorption cycle.

Additionally, polymers, especially polyamines, can also suffer from oxidation when exposed to oxygen. Many of the CO₂-containing gases where CO₂ removal is desirable can also contain oxygen, with the amount of oxygen possibly being substantially larger than the amount of CO₂ (e.g., air). While degradation of a polymer due to the presence of oxygen can be reduced or minimized by controlling the temperature during exposure to oxygen, improved resistance to oxidation would be desirable to increase the run lengths for a sorbent system while maintaining a target sorption capacity.

It has been discovered that the benefits of using a lower molecular weight polyamine as a CO₂ sorbent can be largely maintained while improving the resistance to oxidation and lowering the volatility. This combination of benefits is achieved by reacting the relatively low molecular weight polyamine with a bidentate (or polydentate) linking reagent in a reduced or minimized amount. In some aspects, the amount of multi-dentate linking reagent is selected so that 0.5 mol % to 30 mol % of the nitrogen atoms in the polyamine are reacted during cross-linking, or 1.0 mol % to 30 mol %, or 2.5 mol % to 30 mol %, or 5.0 mol % to 30 mol %, or 0.5 mol % to 15 mol %, or 1.0 mol % to 15 mol %, or 2.5 mol % to 15 mol %, or 5.0 mol % to 15 mol %, or 1.0 mol % to 9.0 mol %, or 2.5 mol % to 9.0 mol %, or 0.5 mol % to 7.5 mol %, or 1.0 mol % to 7.5 mol %, or 2.5 mol % to 7.5 mol %. It is noted that the amount of nitrogen that is reacted during cross-linking is roughly proportional to the amount of multi-dentate linking reagent. It is believed that the linking reagent can allow for linking between polyamine chains as well as linking within a single polyamine chain. The resulting modified polymer can substantially retain the sorption capacity of the lower molecular weight starting polymer material while having reduced volatility and increased resistance to oxidationIn addition to providing an unexpectedly improved combination of sorption capacity and oxidation resistance, the modified polymer material can also be formed in a relatively straightforward manner. In particular, the polyamine reagent does not need to be reacted or functionalized prior to reacting the polyamine with the linker. In various aspects, the low molecular weight polyamine can correspond to a polymer with an oxygen content of 1.0 wt % or less, or 0.1 wt % or less, such as down to having substantially no oxygen content. Additionally or alternately, the modified polymer material corresponds to a material that can be readily incorporated into/on a solid sorbent, such as a monolith or particles of a refractory oxide and/or zeolite. This can reduce or minimize the difficulties with attempting to build a commercial scale structure that incorporates the sorbent material. Supporting the polymer material can also allow a thin layer to be formed, which can assist with maintaining a higher porosity. This is in contrast to a self-supporting polymer, which typically has a lower porosity in order to maintain structural integrity.

### Formation of Modified Polymer

In various aspects, a modified polymer composition can be formed by reacting a low molecular weight polymeric polyamine with a multi-dentate (such as bi-dentate or tri-dentate) linker compound. Formation of the modified polymer can be achieved in any convenient manner. For example, the polyamine can be dissolved in water, ethanol, and/or another suitable solvent to form a solution with a lower viscosity than the neat polyamine. The multi-dentate linker can then be added to the solution. The solution can be maintained at a reaction temperature, such as 0° C. to 50° C., for a reaction time of 0.1 hours to 10 hours, or 0.1 hours to 2.0 hours to form the modified polymer material. Optionally but preferably, the solution can be stirred or mixed during the reaction time. In some aspects, a support material can then be added to the solution containing the modified polymer material to impregnate the modified polymer on a support. The support material can be contacted with the modified polymer at a temperature of 20° C. to 75° C. for an impregnation time of 0.1 hours to 10 hours, or 0.1 hours to 2.0 hours to form a supported modified polyamine material. The impregnated support material can then be dried to remove the water.

For the low molecular weight polymeric polyamine, a variety of types of polyamine polymers can be suitable. Polyethyleneimine (PEI) is an example of a suitable polyamine. Other types of polyamine polymers (including polyimines) can also be used, such as polyhydroxylamine. Still other examples of polyamines include, but are not limited to, polyvinylamine, polypropyleneimine, polyallylamine, poly(2-dimethylaminoethyl acrylate), poly(2-dimethylaminoethyl methacrylate) and other vinyl polymers. In some aspects, the polyamine can correspond to a functionalized polyamine. Prior to reaction with the multi-dentate linker, the polyamine can correspond to a branched or a non-branched polymer chain.

Generally, the low molecular weight polyamine can have a weight average molecular weight of 500 Da (Daltons) to 15,000 Da, or 500 Da to 10,000 Da, or 500 Da to 5,000 Da, or 500 Da to 2,000 Da, or 500 Da to 1,500 Da. Additionally or alternately, the low molecular weight polyamine can have a number average molecular weight of 500 Da (Daltons) to 5,000 Da, or 500 Da to 2,500 Da, or 500 Da to 1,300 Da, or 500 Da to 1,000 Da. It is noted that for many types of polymers, there is a difference between the number average molecular weight and the weight average molecular weight (i.e., polydispersity). Polydispersity is defined as the ratio of the weight average molecular weight divided by the number average molecular weight. In some aspects, the polydispersity for the polyamine can be 1.5 or less, or 1.4 or less, or 1.3 or less, such as down to 1.0 (i.e., having substantially no polydispersity).

The multi-dentate linker can correspond to a compound that includes functional groups that are suitable for functionalizing an amine. Examples of such compounds include di-epoxies, tri-epoxies, and di-aldehydes. 1,2,7,8 diepoxyoctane (DENO) is an example of a di-epoxy compound that can be used to form a modified polymer material.

In various aspects, the amount of multi-dentate linker in the synthesis solution for forming the modified polymer can correspond to 0.5 wt % to 33 wt % of the combined amount of low molecular weight polyamine and linker in the synthesis solution, or 0.5 wt % to 25 wt %, or 0.5 wt % to 15 wt %, or 0.5 wt % to 10 wt %, or 2.0 wt % to 33 wt %, or 2.0 wt % to 25 wt %, or 2.0 wt % to 15 wt %, or 2.0 wt % to 10 wt %, or 4.0 wt % to 33 wt %, or 4.0 wt % to 25 wt %, or 4.0 wt % to 20 wt %, or 4.0 wt % to 15 wt %, or 4.0 wt % to 10 wt %. Preferably, the amount of multi-dentate linker corresponds to 20 wt % or less of the combined amount of low molecular weight polymine and linker in the synthesis solution, or 15 wt % or less, or 10 wt % or less, such as down to 0.5 wt % or possibly still less. Using such a reduced or minimized amount of the multi-dentate linker can result in reaction of a corresponding reduced or minimized amount of nitrogen atoms in the polyamine, so that the stability benefits are achieved while retaining a high CO₂ capacity in a supported amine material. It is noted that this is a weight percent relative to only the combined amount of polyamine and linker in the synthesis solution; any support material, solvent, and/or other components in the solution are not included in this relative weight percentage. This corresponds to a weight ratio of polyamine to linker in the synthesis solution of roughly 2.0 (i.e., 2.0:1) or more, or 4.0 or more, or 5.0 or more, or 15 or more, or 20 or more, such as up to 200 or possibly still more, or up to 250 or possibly still more. For a comparison on a molar basis, the weight of a monomer of the polyamine can be used as the basis for making a molar comparison with the linker. On a molar basis, the ratio of moles of polyamine monomer to moles of linker can be 5.0 to 1000, or 5.0 to 650, or 5.0 to 350, or 9.0 to 1000, or 9.0 to 650, or 9.0 to 350, or 18 to 1000, or 18 to 650, or 18 to 350, or 30 to 1000, or 30 to 650, or 30 to 350.

In various aspects, due to the nature of the modified polyamine material, the modified polyamine material can be used as a supported modified polyamine material when using the material for sorption/desorption of CO₂. For such a supported modified polyamine material, using a reduced or minimized amount of the multi-dentate linker can result in a supported modified polyamine having an equilibrium CO₂ capacity of 0.5 mmol CO₂/g polyamine or higher at 35° C. in the presence of 100 kPa of CO₂, or 1.5 mmol CO₂/g polyamine or higher, or 2.3 mmol CO₂/g polyamine or higher, or 2.5 mmol CO₂/g polyamine or higher, or 2.7 mmol CO₂/g polyamine or higher, or 3.0 mmol CO₂/g polyamine or higher, such as up to 7.0 mmol CO₂/g polyamine or possibly still higher. Additionally or alternately, in various aspects, the supported modified polyamine material can retain 60% or more of a maximum equilibrium CO₂ capacity after exposure of the supported modified polyamine material to flowing air at 140° C. for 60 minutes in 10 minute intervals, or 65% or more, or 70% or more, or 75% or more, such as up to 85% or possibly still more.

After reacting the low molecular weight (polymeric) polyamine with the multi-dentate linker, the resulting modified polymer material can have an increased molecular weight. In some aspects, the modified polymer material can have a weight average molecular weight be between 1.5 times to 20 times the weight average molecular weight of the polyamine reagent, or 1.5 times to 10 times, or 3.0 times to 20 times. In aspects where the weight average molecular weight of the polyamine reagent is between 500 Da to 1500 Da, the resulting modified polymer material can have a weight average molecular weight of 750 Da to 20,000 Da, or 750 Da to 10,000 Da, or 1500 Da to 20,000 Da, or 1500 Da to 10,000 Da. In such aspects, the polydispersity of the resulting modified polymer material can be between 1.0 to 2.5, or 1.2 to 2.5, or 1.4 to 2.5, or 1.0 to 2.0, or 1.2 to 2.0, or 1.4 to 2.0, or 1.0 to 1.5.

The modified polymer material can also have an unexpectedly high sorption capacity for CO₂ (and/or other potential sorption components) relative to the oxidation resistance of the modified polymer material. Conventionally, lower molecular weight polyamines have improved sorption capacity, but reduced oxidation resistance. It has been discovered that by forming a modified polymer material, the sorption capacity of the underlying low molecular weight polyamine can be substantially retained while providing improved resistance to oxidation. In various aspects, the modified polymer material can have an initial CO₂ sorption capacity that corresponds to 70% or more of the initial sorption capacity of the polyamine reagent, or 80% or more, such as up to 100% or possibly still higher. This sorption capacity can be achieved while reducing or minimizing the loss of sorption capacity over time when the modified polymer material is exposed to the cyclic conditions encountered in a sorption/desorption process.

It is noted that in some aspects, the cross-linked material described herein has a reduced or minimized amount of pore volume (such as substantially no pore volume) unless it is supported on a support material. In such aspects, the cross-linked material described herein, as a self-supported material (such as in the form of particles), can have a pore volume of 25 m²/g or less, or 10 m²/g or less, such as down to substantially no pore volume.

### Conditions for Sorption/Desorption Cycle

In various aspects, a polyamine material, such as a modified polyamine material, optionally supported on a support material, can be used in a process for selectively sorbing a component from a fluid phase flow, and then desorbing the sorbed component to perform a cyclic sorption/desorption process. In some aspects, CO₂ can be the component that is selectively sorbed and desorbed. In other aspects, any other convenient component which can undergo chemisorption and/or adsorption at amine sites can be the component that is selectively sorbed and desorbed.

An example of a component that can be sorbed/desorbed is CO₂. One option for performing a CO₂ sorption/desorption cycle is to use temperature to facilitate sorption and then desorption of the CO₂. For example, a sorbent material can be exposed to CO₂ at a lower temperature in order to sorb CO₂, followed by increasing the temperature of the material to desorb the CO₂.

In some aspects, sorption of CO₂ can be performed by exposing the modified polymer material to CO₂ at a temperature between 0° C. and 70° C., or 15° C. to 70° C., or 0° C. to 50° C., or 15° C. to 50° C. During sorption, the modified polymer is exposed to a fluid (typically gas phase) stream containing multiple components, with one of the components corresponding to CO₂. The CO₂ concentration in the fluid stream can vary widely depending on the application. In some aspects such as a direct air capture system, the CO₂ concentration can be relatively low, such as a CO₂ concentration of 100 vppm to 1000 vppm, or 100 vppm to 600 vppm. In other aspects, the fluid stream can have higher CO₂ concentration, such as a CO₂ concentration of 0.1 vol % to 10 vol %, or possibly still higher. The total pressure during the sorption step can range from 70 kPa-a to 10,000 kPa-a, or 70 kPa-a to 5,000 kPa-a, or 70 kPa-a to 1,000 kPa-a, or 100 kPa-a to 10,000 kPa-a, or 100 kPa-a to 5,000 kPa-a, or 100 kPa-a to 1,000 kPa-a.

After a sorption step, a different set of conditions can be used for desorption. In a temperature swing cycle, desorption can be facilitated by increasing the temperature of the sorbent environment. Optionally, the pressure can also be decreased. In some aspects, desorption of CO₂ can be performed at a temperature of 70° C. to 200° C., or 70° C. to 170° C., or 70° C. to 140° C., or 90° C. to 200° C., or 90° C. to 170° C., or 90° C. to 140° C., or 110° C. to 200° C., or 110° C. to 170° C. Optionally, the temperature during desorption can be greater than the temperature during sorption by 30° C. or more, or 50° C. or more, such as up to 110° C. or possibly still more. The total pressure during the sorption step can range from 70 kPa-a to 10,000 kPa-a, or 70 kPa-a to 5,000 kPa-a, or 70 kPa-a to 1,000 kPa-a, or 100 kPa-a to 10,000 kPa-a, or 100 kPa-a to 5,000 kPa-a, or 100 kPa-a to 1,000 kPa-a. Optionally, the pressure during desorption can be similar to the pressure during sorption. Optionally, the pressure during desorption can be lower than the pressure during sorption by 20 kPa or more, or 50 kPa or more, or 100 kPa or more, such as up to 8000 kPa or possibly still more. In some aspects, a sweep fluid can be passed over and/or through the sorbent environment during desorption to assist with removing the desorbed CO₂.

### Example 1—Support Materials

A series of support materials were prepared or acquired. Table 1 shows the materials, including several comparative examples. In Table 1, largest diffusing sphere refers to the largest diffusing sphere that can pass through the pore network of the material. The properties in Table 1 correspond to properties that are inherent to the crystalline framework structure. It is noted that the silica-alumina material shown in Table 1 corresponds to a material based on Siral 40 HPV, which is a commercially available silica-alumina material.

TABLE 1
Support Materials

| Support Materials | Ring Size | Largest Diffusing Sphere |
|---|---|---|
| ERS-8 (Comparative) | Amorphous | Infinite |
| LTA (Comparative) | 8 | 4.2 |
| FAU (Comparative) | 12 | 7.4 |
| SiO₂—Al₂O₃ (high pore | Amorphous | infinite |
| volume, high | | |
| mesopore, sufficient | | |
| acidity) | | |

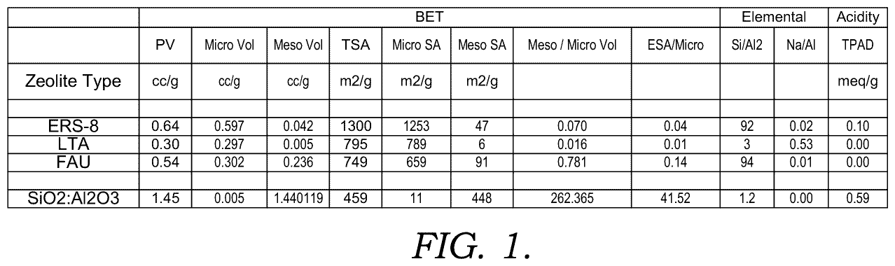

FIG. 1 shows additional characterization for the support materials in Table 1. The inventive amorphous support material shown in Table 1 and FIG. 1 was synthesized in order to achieve the combination of properties shown in FIG. 1. As shown in FIG. 1, the inventive amorphous support materials have a combination of properties as described herein. This combination of properties includes a pore volume of 1.2 cm³/g or more, a ratio of mesopore volume to micropore volume of 1.0 or more, a total surface area of 350 m²/g or more, at least 20 wt % silica content, and an acidity (TPAD) of 0.1 meq/g or more. By contrast, each of the comparative examples lacks one of these properties. For the ERS-8 comparative example, in addition to being an amorphous material, the ratio of mesopore volume to micropore volume is well below 1.0. For the LTA example, the ratio of mesopore volume to micropore volume is less than 1.0, and the acidity is below 0.1 meq/g. For the FAU example, the ratio of mesopore volume to micropore volume is less than 1.0 and the acidity is below 0.1 meq/g.

### Example 2—CO₂ Sorption with Supported Amines

PEI was deposited on the support materials shown in FIG. 1 to allow for characterization of CO₂ capacity.

To determine CO₂ capacity via TGA, samples were first exposed to a purge procedure. The samples were initially ramped to 110° C. at roughly 10° C. per minute under 1 atm (˜100 kPa-a) of nitrogen. The samples were held at 110° C. for roughly 4 hours. The samples were then cooled under nitrogen at roughly 10° C. per minute to reach a temperature of 35° C. The samples were held at 35° C. under the nitrogen for roughly 30 minutes. The gas phase environment was then replaced with 1 atm (˜100 kPa-a) of CO₂. The samples were held at 35° C. under the CO₂ for roughly 3 hours. The weight of the sample was monitored using the TGA device during these steps to characterize the CO₂ capacity.

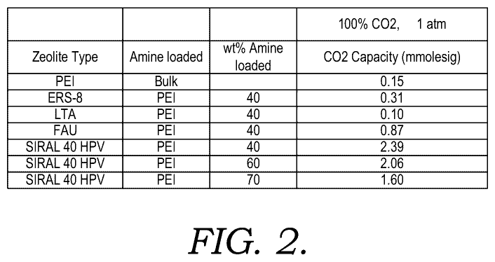

FIG. 2 shows results from the characterization of CO₂ capacity. The capacity was collected on a TGA using 100% CO₂ at 1 atmosphere after being dried in nitrogen. The loading of the polyamine on the support material is shown along with the CO₂ capacity. It is noted that all of the polyamine loadings correspond to at least 30 wt % of the weight of the support material.

As shown in FIG. 2, the inventive amorphous support materials provided a substantial advantage for the CO₂ capacity of the supported amine relative to either a self-supported version of the amine or the amine supported on a conventional support. It is noted that even at 70 wt % amine supported on the inventive amorphous support material, the CO₂ capacity per gram of amine is substantially higher than the comparative examples where 40 wt % amine is supported on a comparative support material.

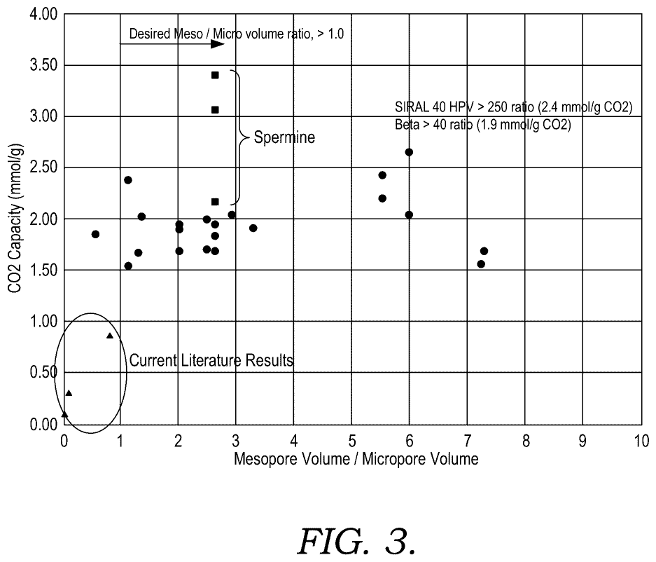

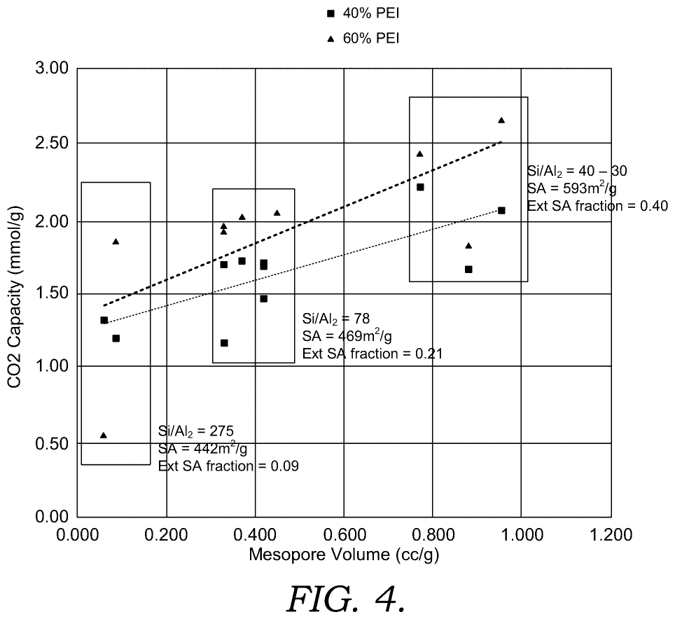

FIG. 3 further illustrates the benefits of having ratio of mesopore volume to micropore volume of 1.0 or more. In FIG. 3, PEI was loaded in an amount of 40 wt % to 60 wt % relative to the weight of the support material. In FIG. 3, two conventional comparative materials are shown that have a ratio of mesopore volume to micropore volume of less than 1.0. As shown in FIG. 4, the polyethylene imine on those support materials has a capacity substantially below 1.5 mmol/g. By contrast, for the amorphous support materials having a ratio of greater than 1.0 for mesopore volume to micropore volume shown in FIG. 4, all of the materials had a CO₂ capacity of greater than 1.5 mmol/g.

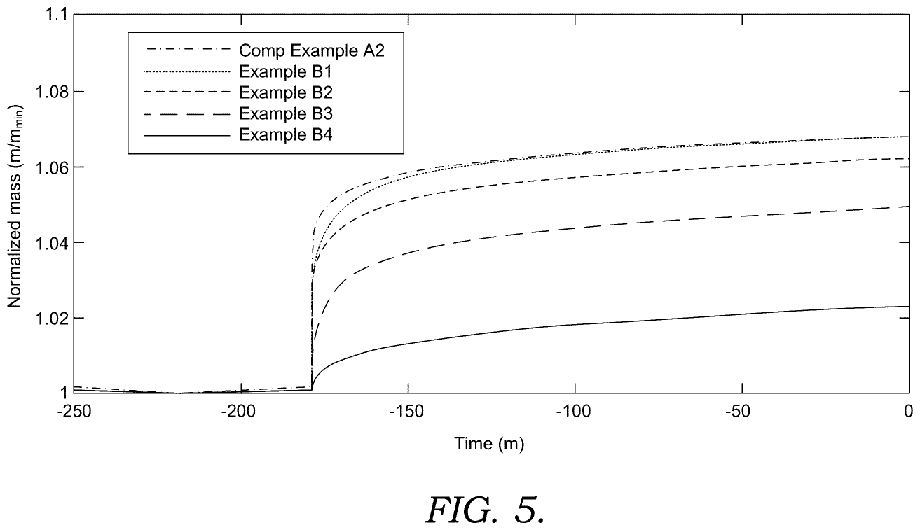

FIG. 4 illustrates the impact of mesoporosity on the CO₂ sorption capacity of PEI supported on a support material. To isolate the impact of this factor, a series of EMM-57 samples with different mesopore volumes were studied. In FIG. 5, the EMM-57 were tested with either 40 wt % (square data points) or 60 wt % (triangle data points) relative to the weight of the support material. Although EMM-57 is a crystalline material, it is believed that the trend for mesopore volume alone shown in FIG. 4 also applies to amorphous silica-alumina materials.

As shown in FIG. 4, increasing the mesopore volume itself provides only a modest increase in CO₂ sorption capacity for a given type of zeolitic material. This further confirms that the ratio of mesopore volume to micropore volume is the stronger correlation with increased CO₂ sorption.

### Examples 3 to 7—Supported Amine Polymers

In the following examples, two types of supported amine-based polymers are tested for CO₂ sorption/desorption properties, volatility, and oxidative stability.

One type of supported polymer system (Comparative Example A) corresponds to polyethyleneimine (PEI) supported on a particulate support material. Materials corresponding to Comparative Example A were formed by diluting PEI in either water or ethanol to make a low viscosity solution. A powder of high surface area support material was then added to the solution and mixed at 50° C. for 24 hrs, followed by drying under nitrogen atmosphere to produce Comparative Example A.

The other type of supported polymer system (Example B) corresponded to a modified polymer material impregnated on the same type of support. Materials corresponding to Sample B were formed by diluting PEI in ethanol to make a low viscosity solution. Next, 1,2,7,8 diepoxyoctane (DENO) was added to the PEI/EtOH solution at ambient temperature (roughly 20° C.) and stirred for 30 minutes. Over this time, the DENO and the PEI reacted to form a modified polymer material with higher molecular weight. After 30 minutes, the powder of high surface area support material was added to the solution and mixed at 50° C. for 24 hrs, followed by drying under nitrogen atmosphere to produce Sample B.

### Example 3—CO₂ Capacity

The two types of materials were tested for CO₂ capacity. Table 2 shows the relative amounts of PEI, support, and DENO (if any) that were used to make the various samples. Table 2 also shows the amount of CO₂ uptake in millimoles of CO₂ per gram of either PEI or PEI plus support. It is noted that for the samples including DENO, the DENO is not included in the calculation of CO₂ capacity when using units of mmol/g PEI.

The CO₂ capacity values were determined by thermogravimetric analysis (TGA). To determine CO₂ capacity, samples were first exposed to a purge procedure. The samples were initially ramped to 110° C. at roughly 10° C. per minute under 1 atm (˜100 kPa-a) of nitrogen. The samples were held at 110° C. for roughly 4 hours. The samples were then cooled under nitrogen at roughly 10° C. per minute to reach a temperature of 35° C. The samples were held at 35° C. under the nitrogen for roughly 30 minutes. The gas phase environment was then replaced with 1 atm (˜100 kPa-a) of CO₂. The samples were held at 35° C. under the CO₂ for roughly 3 hours. The weight of the sample was monitored using the TGA device during these steps in order to characterize the CO₂ capacity.

As shown in Table 2, addition of low levels of DENO to form a modified polymer material results in a modified polymer material with comparable levels of CO₂ capacity to the unmodified PEI. Thus, the modified polymer material had similar CO₂ capacity to unmodified PEI at weight ratios of PEI to DENO of roughly 10 or more (molar ratio of PEI monomer units to DENO of roughly 30 or more, as defined herein). At lower ratios of PEI to DENO (weight ratio less than 9.0, molar ratio less than roughly 30), however, the CO₂ capacity started to drop. This drop becomes more pronounced at weight ratios of PEI to DENO lower than 4.0 (molar ratio less than roughly 13). FIG. 5 shows the thermogravimetric analysis (TGA) results corresponding to the capacities shown in Table 2.

TABLE 2
Samples and CO₂ Capacities

| | Impreg T | PEI | Support | DENO | PEI | DENO | CO2 capacity | CO2 capacity |
|---|---|---|---|---|---|---|---|---|
| Example | (C.) | (g) | (g) | (g) | (wt. %) | (wt. %) | (mmol/g) | (mmol/g PEI) |
| Comp. | 50 | 3 | 3 | 0 | 50 | 0 | 1.8 | 3.6 |
| Example A1 | | | | | | | | |
| Comp. | 50 | 3 | 3 | 0 | 50 | 0 | 1.5 | 3.1 |
| Example A2 | | | | | | | | |
| Example B1 | 50 | 0.996 | 1.02 | 0.05 | 48.2 | 2.4 | 1.5 | 3.2 |
| Example B2 | 50 | 1.02 | 1.03 | 0.099 | 47.5 | 4.6 | 1.4 | 3.0 |
| Example B3 | 50 | 1.008 | 1.05 | 0.205 | 44.5 | 9.1 | 1.1 | 2.5 |
| Example B4 | 50 | 1.011 | 1 | 0.398 | 42.0 | 16.5 | 0.5 | 1.2 |

### Example 4—Volatility and Thermal Stability

Differential thermal analysis (DTA) was used to characterize the volatility and oxidative stability of the various samples. The DTA was performed in the same apparatus used for the TGA analysis in Example 3. To investigate volatility, samples corresponding to Examples A2, B1, B2, B3, and B4 were each ramped to 140° C. at a rate of 5° C. per minute under nitrogen. The samples were then held at 140° C. for roughly 4 hours to measure the mass loss (volatility) due to exposure to 140° C. for an extended period. At the end of the roughly 4 hours, the gas phase environment for the samples was switched to air. The samples were then held at 140° C. for roughly another 4 hours to determine mass loss due to formation of volatile compounds via oxidation.

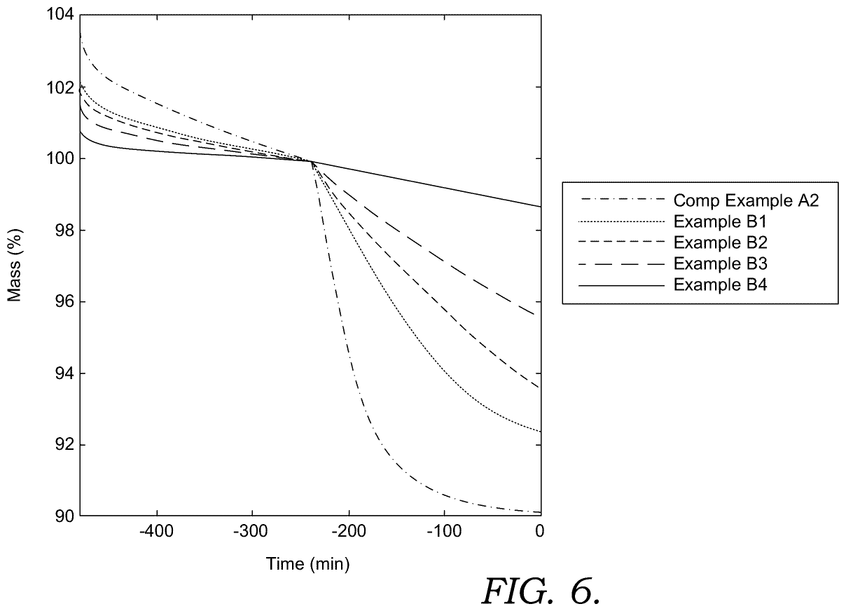

FIG. 6 shows the results from the DTA runs. In FIG. 6, the weight of each sample was normalized so that the weight at the end of the N₂ exposure at 140° C. corresponds to 100% mass. The end of the N₂ exposure at 140° C. is assigned a time of 0 minutes in FIG. 6. Thus, times prior to 0 minutes correspond to the change in mass due to volatility of the polymer, while times after 0 minutes correspond to the change in mass due to oxidation of polymer to volatile compounds.

As shown in FIG. 6, the modified polymer materials have a decrease in volatility and increase in oxidation resistance that is roughly proportional to the amount of linker used to make the modified polymer. As noted in Example 3, however, the change in CO₂ capacity was not linear with increase in the amount of linker in the modified polymer material. Instead, use of sufficiently low amounts of linker resulted in a modified polymer material with substantially the same CO₂ capacity as the unmodified PEI. Thus, the combination of FIG. 5 and FIG. 6 illustrate the unexpected nature of the modified polymer materials when the amount of linker is sufficiently low. A benefit of improved oxidation resistance and lowered volatility is achieved for the modified polymer while substantially retaining the CO₂ capacity of the unmodified polymer.

It is noted that the reduced volatility benefits shown in FIG. 6 will be mitigated as the weight average molecular weight of the initial polyamine reagent is increased. However, it is believed the oxidative resistance benefits are retained, independent of the polymer size of the initial polyamine reagent.

### Example 5—Cyclical Exposure to Oxidizing and Sorption Environments

To further illustrate the benefits of the modified polymer materials with regard to improving material lifetime (e.g., slowing down oxidative degradation that retards CO₂ adsorption), cyclical oxidation/CO₂ uptake tests were performed. In this example, the CO₂ capacity of a sample corresponding to Example A1 was compared with a sample corresponding to Example B2 after cyclic exposure to air at temperatures of either 120° C. or 140° C.

The cyclic process was performed using the TGA unit. The cyclic process of oxidation, CO₂ sorption, and CO₂ desorption was performed as follows. First, to prepare a sample, the sample was ramped at 10° C./min to 140° C. under N₂. The sample was then held at 140° C. for roughly 180 minutes under N₂ to desorb any CO₂ or H₂O. The sample was then cooled at 10° C./min to 35° C. After reaching 35° C., the gas phase environment was switched to CO₂. The temperature was maintained at 35° C. in the presence of the CO₂ for roughly 30 minutes to measure a baseline CO₂ capacity. The gas phase environment was then purged with N₂.

At this point, the cyclic process was started. First, the temperature of the sample was ramped to either 120° C. or 140° C. at 10° C./min under the N₂ gas phase environment. The gas phase environment was then switched to air. The temperature of either 120° C. or 140° C. was maintained for roughly 10 minutes in the presence of the air gas phase environment. The gas phase environment was then purged with N₂. Next, the temperature was ramped down to 35° C. at 10° C./min. The gas phase environment was then switched to CO₂, and the sample was held at 35° C. for roughly 30 minutes in the presence of the CO₂ gas phase environment to measure a new CO₂ capacity. The process was then repeated to measure how cyclic oxidation impacted CO₂ capacity over time.

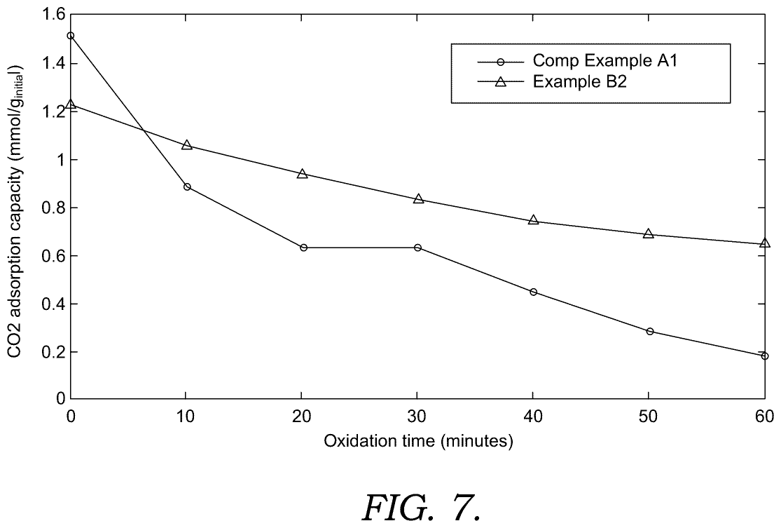

FIG. 7 shows the CO₂ capacity results from cyclic exposure of the A1 (Comparative) and B2 (modified polymer material) samples at 140° C. during the oxidation step. As shown in FIG. 7, the modified polymer material initially provided comparable CO₂ capacity to the unmodified PEI. Over time, the modified polymer material retained a substantial portion of the initial CO₂ capacity. By contrast, the unmodified PEI sample rapidly dropped to having less than half of the initial CO₂ capacity, and continued to lose additional CO₂ capacity at longer times.

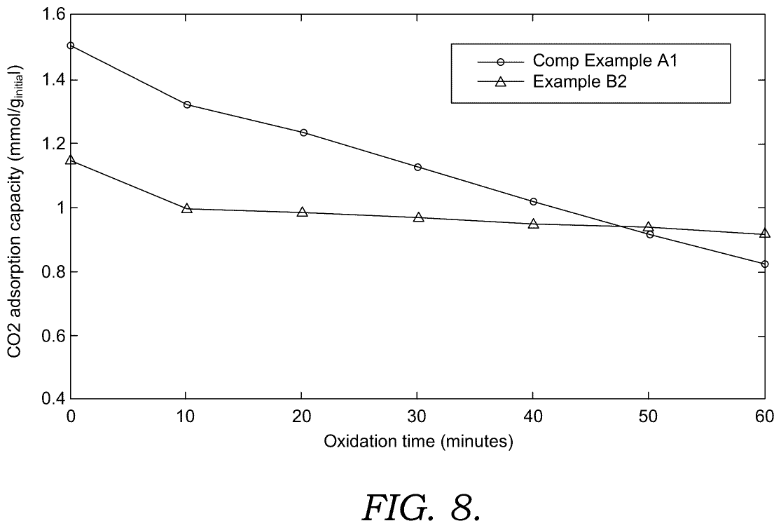

FIG. 8 shows the CO₂ capacity results from cyclic exposure at 120° C. during the oxidation step. As shown in FIG. 8, the degradation of the unmodified PEI is slower, but the modified polymer material still provides a substantial advantage in retaining the initial level of CO₂ capacity.

### Example 6—Additional Kinetic and Capacity Characterization

An additional unexpected finding was that using relatively low amounts of a linking agent to form a modified polymer resulted in a modified polymer that had sorption kinetics that were comparable to the unmodified polymer. This was determined based on additional characterization of the samples described in Table 2. This additional characterization corresponded to “breakthrough” characterization.

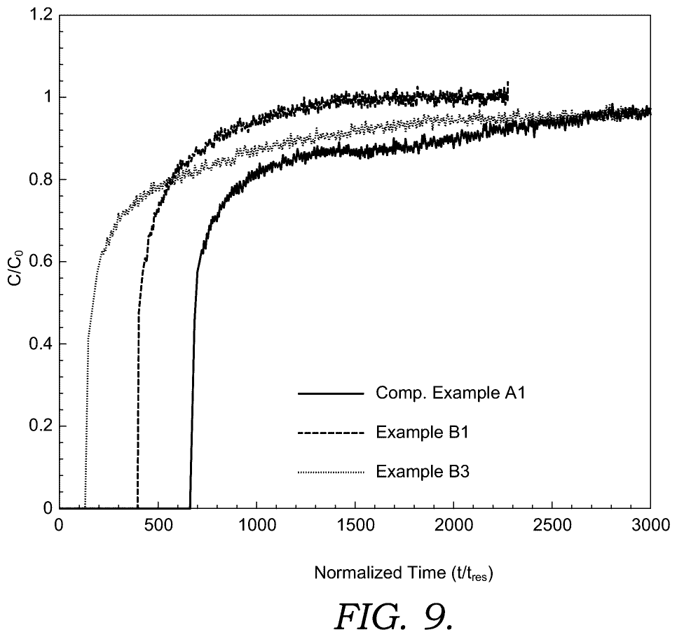

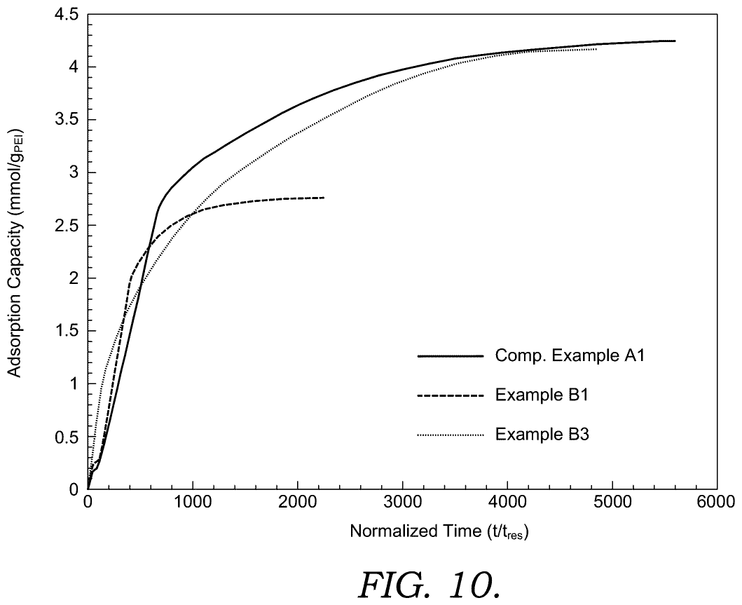

For this additional characterization, all samples were sieved to 425-250 microns. The samples were then packed into a column and heated under a flow of 100 sccm N₂ to 100° C. for 16 hours. The samples were then placed on a breakthrough test unit with high-speed switching valves. A stream of 8333 ppm CO₂ in N₂ was delivered to the packed bed maintained at 30° C. in a furnace. The effluent gas stream was measured via mass spectrometry (see FIG. 9). An in-line flow meter was used to convert the breakthrough curve to an adsorption curve (see FIG. 10).

As shown in FIG. 9 and FIG. 10, Comparative Example A1 from Table 2 (unmodified PEI) exhibited a larger capacity (FIG. 9) with a substantial contribution from fast CO₂ adsorption kinetics (FIG. 10). Modified PEI Example B1 had a smaller overall capacity (FIG. 9), but exhibited similarly fast kinetics (FIG. 10) compared to Comparative Example A1. Thus, even though some capacity was lost, the resulting modified polymer unexpectedly had sorption kinetics similar to an unmodified polymer. Example B3 had larger overall capacities (FIG. 9) comparable to Comparative Example A1, but a larger component of that capacity corresponded to slow kinetics (FIG. 10) as indicated by a slow approach to the original CO₂ concentration of the feed.

### Example 7—NMR Quantification of Amines

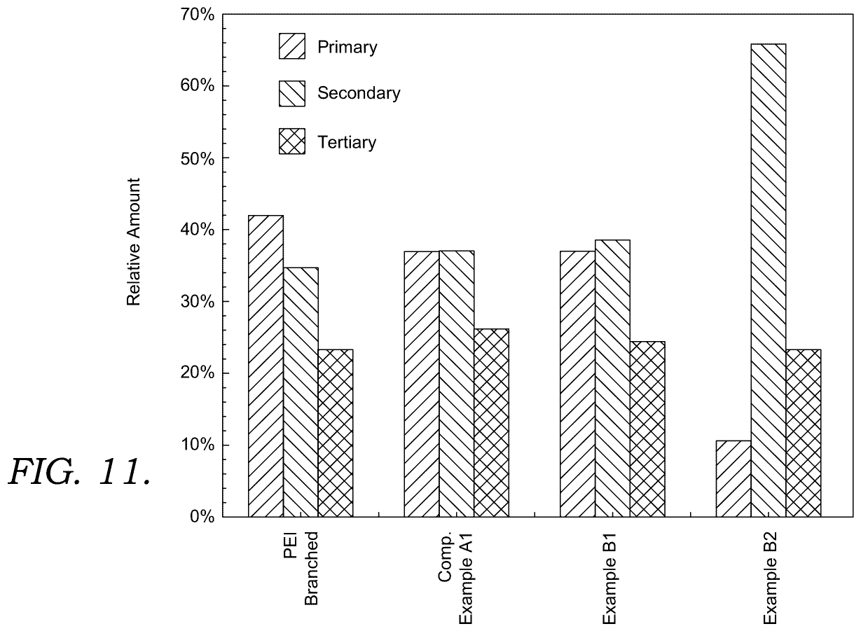

The types of amines present in the unmodified and modified PEI samples were characterized using nuclear magnetic resonance (NMR) spectroscopy. FIG. 12 shows a plot summarizing the quantification of the primary, secondary, and tertiary amines of the neat PEI, supported PEI (Comp. Example A1), and select modified PEI samples (Example B1 and Example B2). To perform this analysis, samples were prepared by sonicating a slurry of powdered PEI/support in a solution of deuterated chloroform. The samples were then filtered and prepared for ¹³C NMR measurements. The primary, secondary, and tertiary amines were quantified using assignments published by Choi et al (Nat. Commun. 7:12640 doi: 10.1038/ncomms12640 (2016)). FIG. 11 shows that the epoxidation of the sample selectively occurs on the primary amines to create additional secondary amines under these reaction conditions. It is noted that the quantity of tertiary amines is relatively constant in all samples.

### Example 8—Cross-linked Amines and CO₂ Capacity

By using NMR quantification, the percentage of amines in a polyamine sample that participate in cross-linking can be quantified. This procedure is described in an article by Choi et al., (Nat. Commun. 7:12640 doi: 10.1038/ncomms12640 (2016)). Briefly, a sample of the polyamine prior to reaction (such as unmodified PEI) can be characterized using ¹³C-NMR to characterize the number of primary, secondary, and tertiary amines in the sample. A sample after cross-linking (such as modified PEI) can then be characterized in a similar manner. By characterizing the change in the number of primary, secondary, and tertiary amines before and after modification, the degree of cross-linking can be determined.

It has been discovered that the benefits of cross-linking the polyamine can be achieved at a relatively low level of cross-linking. By performing a reduced or minimized amount of cross-linking, the unexpected combination of increasing stability while preserving CO₂ capacity can be achieved.

A series of supported amines were prepared by forming cross-linked polyethyleneimine (PEI) on EMM-57. The cross-linking agent was 1,2,7,8-diepoxyoctane (DENO). Table 3 shows characterization of the cross-linked PEI, including the relative amounts of PEI, EMM-57, and DENO used to form the supported cross-linked amine composition and the resulting CO₂ capacities.

TABLE 3
CO₂ Capacity of Cross-Linked PEI

| % N in | | | | | |
|---|---|---|---|---|---|
| PEI | PEI | EMM-57 | DENO | CO2 capacity | CO2 capacity |
| reacted | (wt %) | (wt %) | (wt %) | (mmol/g) | (mmol/g PEI) |
| 3% | 48.21 | 49.37 | 2.42 | 1.54 | 3.20 |
| 6% | 47.46 | 47.93 | 4.61 | 1.41 | 2.98 |
| 12% | 44.54 | 46.40 | 9.06 | 1.12 | 2.51 |
| 24% | 41.97 | 41.51 | 16.52 | 0.52 | 1.24 |

As shown in Table 3, the percentage of N atoms reacted in the PEI increases roughly linearly with the amount of cross-linking agent. When the percentage of N atoms in the polyamine that are reacted during cross-linking is greater than 9.0 mol %, the CO₂ capacity of the resulting supported amine drops dramatically. increasing the amount of DENO relative to the amount of PEI (or other amine) results in an increase in the percentage of nitrogens in the PEI that are reacted. Table 3 shows characterization of additional supported amine samples based on PEI, EMM-57, and optionally DENO as a cross-linking agent.

TABLE 4
Characterization of Additional Samples

| EMM-57 | DENO | PEI | DENO | Epoxy/amine | CO2 capacity | CO2 capacity | |
|---|---|---|---|---|---|---|---|
| (wt %) | (wt %) | (mmol) | (mmol) | (%) | (mmol/g) | (mmol/g PEI) | |
| 50 | 0 | ~23 | 0 | N/A | 1.8 | 3.7 | 3.6 |
| 50 | 0 | ~23 | 0 | N/A | 1.9 | 3.9 | |
| 50 | 0 | ~23 | 0 | N/A | 1.8 | 3.6 | |
| 50 | 0 | ~23 | 0 | N/A | 1.5 | 3.1 | |
| 49.4 | 2.4 | 23.1 | 0.4 | 3.0 | 1.5 | 3.2 | |
| 47.9 | 4.6 | 23.7 | 0.7 | 5.9 | 1.4 | 3.0 | |
| 46.4 | 9.1 | 23.4 | 1.4 | 12.3 | 1.1 | 2.5 | |
| 41.5 | 16.5 | 23.5 | 2.8 | 23.9 | 0.5 | 1.2 | |

In Table 4, all of the samples include roughly the same amount of PEI supported on roughly the same amount of EMM-57. The only difference is that some samples are cross-linked with various amounts of DENO. As shown in Table 4, the PEI samples without cross-linker have an average CO₂ capacity of 3.6 mmol CO₂/g PEI. When less than 7.6 wt % of DENO is included as a cross-linker, the CO₂ capacity remains above 2.8 mmol CO₂/g PEI. However, further increases in the amount of PEI result in a sharp drop in CO₂ capacity.

Table 5 shows characterization of additional supported amine samples based on PEI, Siral-40HPV, and optionally DENO as a cross-linking agent.

TABLE 5
Characterization of Additional Samples with Siral 40HPV

| Siral 40HPV | DENO | PEI | DENO | Epoxy/amine | CO2 capacity | CO2 capacity |
|---|---|---|---|---|---|---|
| (wt %) | (wt %) | (mmol) | (mmol) | (%) | (mmol/g) | (mmol/g PEI) |
| 55.2 | 7.5 | .016 | .002 | 12 | 1.44 | 3.86 |
| 57.6 | 3.9 | .016 | .001 | 6 | 2.00 | 5.18 |

In Table 6, oxidation experiments were conducted where CO₂ was first adsorbed at 35° C. (0 min in Table 6), then nitrogen was passed over the sample while heating to 140° C., followed by air flow for 10 minutes. This was repeated 6 times to give 60 total minutes of air oxidation at 140° C., where CO₂ capacity was measured after each 10 minute oxidation step. Table 6 shows the results, where normalized CO₂ capacity is listed at 20 minute intervals.

TABLE 6
Characterization of Additional Samples with EMM-57

| | | | Normalized CO2 capacity (mmol CO2/g) | | | |
|---|---|---|---|---|---|---|
| EMM-57 | PEI | DENO | 0 | 20 | 40 | 60 |
| (wt. %) | (wt. %) | (wt. %) | min | min | min | min |
| 47.6 | 47.6 | 4.8 | 1.00 | 0.83 | 0.73 | 0.70 |
| 49.6 | 49.5 | 1.0 | 1.00 | 0.67 | 0.58 | 0.40 |
| 49.8 | 49.7 | 0.5 | 1.00 | 0.61 | 0.49 | 0.25 |

### Additional Embodiments

Embodiment 1. A supported amine sorbent, comprising: an amorphous support material comprising silica and alumina, the support material comprising a pore volume of 1.00 g/cm³ or more, a ratio of mesopore volume to micropore volume of 1.0 or more, a total surface area of 100 m²/g or more, a ratio of Si to Al₂ of 10-49, and an acidity as measured by temperature programmed ammonia desorption of 0.10 meq/g or more; and 30 wt % to 80 wt % of a polyamine supported on the support material, relative to a weight of the support material.
Embodiment 2. The supported amine sorbent of Embodiment 1, wherein the support material comprises a pore volume of 1.20 g/cm³ or more.
Embodiment 3. The supported amine sorbent of any of the above embodiments, wherein the support material comprises a ratio of external surface area to total surface area of 0.15 or more.
Embodiment 4. The supported amine sorbent of any of the above embodiments, wherein the support material comprises a total surface area of 200 m²/g or more.
Embodiment 5. The supported amine sorbent of any of the above embodiments, wherein the support material comprises a total surface area of 350 m²/g or more.
Embodiment 6. The supported amine sorbent of any of the above embodiments, wherein the support material comprises an acidity of 0.15 meq/g or more.
Embodiment 7. The supported amine sorbent of any of the above embodiments, wherein the support material comprises an average pore diameter between 2.0 nm and 50 nm.
Embodiment 8. The supported amine sorbent of any of the above embodiments, wherein the support material comprises a combined weight of silica and alumina of 90 wt % or more relative to a weight of the support material.
Embodiment 9. The supported amine sorbent of any of the above embodiments, wherein the support material comprises 20 wt % or more of alumina.
Embodiment 10. The supported amine sorbent of any of the above embodiments, wherein the polyamine comprises polyethylene imine, polypropylene imine, polyhydroxylamine, a functionalized polyamine, or a combination thereof.
Embodiment 11. The supported amine sorbent of any of the above embodiments, wherein the polyamine comprises a crosslinked polymeric amine, or wherein the polyamine comprises a branched polyamine, or a combination thereof.
Embodiment 12. The supported amine sorbent of any of the above embodiments, wherein the polyamine comprises an average molecular weight of 200 g/mol to 100,000 g/mol.
Embodiment 13. The supported amine sorbent of any of the above embodiments, wherein the polyamine comprises a number average molecular weight of 200 Da to 2000 Da.
Embodiment 14. The supported amine sorbent of any of the above embodiments, further comprising a monolith, the supported amine sorbent being supported on one or more surfaces of the monolith.

While the present invention has been described and illustrated by reference to particular embodiments, those of ordinary skill in the art will appreciate that the invention lends itself to variations not necessarily illustrated herein. For this reason, then, reference should be made solely to the appended claims for purposes of determining the true scope of the present invention.

What is claimed is:

1. A supported amine sorbent, comprising:
an amorphous support material comprising silica and alumina, the support material comprising a pore volume of 1.00 g/cm³ or more, a ratio of mesopore volume to micropore volume of 1.0 or more, a total surface area of 100 m²/g or more, a ratio of Si to Al₂ of 10-49, and an acidity as measured by temperature programmed ammonia desorption of 0.10 meq/g or more; and
30 wt % to 80 wt % of a polyamine supported on the support material, relative to a weight of the support material.

2. The supported amine sorbent of claim 1, wherein the support material comprises a pore volume of 1.20 g/cm³ or more.

3. The supported amine sorbent of claim 1, wherein the support material comprises a ratio of external surface area to total surface area of 0.15 or more.

4. The supported amine sorbent of claim 1, wherein the support material comprises a total surface area of 200 m²/g or more.

5. The supported amine sorbent of claim 1, wherein the support material comprises a total surface area of 350 m²/g or more.

6. The supported amine sorbent of claim 1, wherein the support material comprises an acidity of 0.15 meq/g or more.

7. The supported amine sorbent of claim 1, wherein the support material comprises an average pore diameter between 2.0 nm and 50 nm.

8. The supported amine sorbent of claim 1, wherein the support material comprises a combined weight of silica and alumina of 90 wt % or more relative to a weight of the support material.

9. The supported amine sorbent of claim 1, wherein the support material comprises 20 wt % or more of alumina.

10. The supported amine sorbent of claim 1, wherein the polyamine comprises polyethylene imine, polypropylene imine, polyhydroxylamine, a functionalized polyamine, or a combination thereof.

11. The supported amine sorbent of claim 1, wherein the polyamine comprises a crosslinked polymeric amine, or wherein the polyamine comprises a branched polyamine, or a combination thereof.

12. The supported amine sorbent of claim 1, wherein the polyamine comprises an average molecular weight of 200 g/mol to 100,000 g/mol.

13. The supported amine sorbent of claim 1, wherein the polyamine comprises a number average molecular weight of 200 Da to 2000 Da.

14. The supported amine sorbent of claim 1, further comprising a monolith, the supported amine sorbent being supported on one or more surfaces of the monolith.
